(19) United States
(12) Patent Application Publication
(10) Pub. No.: US 2023/0034781 A1
(43) Pub. Date: Feb. 2, 2023

(54) SYSTEMS AND METHODS FOR GLOBAL RISK RELATIONSHIP RESOURCE MODEL

(71) Applicants: Genevieve M. Guilmette, Burlington, CT (US); Prabhakara R. Gudipati, Matthews, NC (US); Patricia R. Parsons, New Hartford, CT (US); Mahesh Rapaka, Manchester, CT (US); Yuriy Pavlyuk, Westfield, MA (US); Jason M. Cabral, Simsbury, CT (US)

(72) Inventors: Genevieve M. Guilmette, Burlington, CT (US); Prabhakara R. Gudipati, Matthews, NC (US); Patricia R. Parsons, New Hartford, CT (US); Mahesh Rapaka, Manchester, CT (US); Yuriy Pavlyuk, Westfield, MA (US); Jason M. Cabral, Simsbury, CT (US)

(21) Appl. No.: 17/443,982

(22) Filed: Jul. 29, 2021

(51) Int. Cl. G06Q 40/08; G06F 30/20

(52) U.S. Cl. CPC G06Q 40/08; G06F 30/20

(57) ABSTRACT

A risk relationship resource model data store contains electronic records for risk relationship resource models. Each electronic record includes an electronic record identifier, model version identifier, period definition, and layer information. A computer server retrieves, from the data store, information about a risk relationship resource model including the model version identifier, period definition, and layer information. The computer server may then receive, from a remote user device, an adjustment to the risk relationship resource model and execute the model, including an experience rating process and an exposure rating process, to generate a prospective resource amount (based in part on the period definition and the layer information). Information about the adjusted risk relationship resource model, including an updated model version identifier, may then be stored into the data store. The remote user device may support interactive actuarial interface displays that collect, calculate, and provide information (including the prospective resource amount).

### TECHNICAL FIELD

The present application generally relates to computer systems and more particularly to computer systems that are adapted to accurately and/or automatically provide a global risk relationship resource model.

### BACKGROUND

An enterprise may enter into a risk relationship with another party in exchange for payment of a resource amount. For example, an insurer might enter into a “reinsurance” contract or treaty agreement with another party in exchange for payment of a reinsurance premium. As used herein, the term “reinsurance” may refer to, for example, insurance purchased by an insurance company from another insurer to transfer risks associated with a specific class of policies to the purchasing company. Moreover, a pricing model can be used to help determine an appropriate reinsurance premium amount. In some cases, the pricing model might be implemented via a spreadsheet computer application, such as the EXCEL® spreadsheet application produced by MICROSOFT®. Entering information into such a spreadsheet application, however, can be a time consuming and error prone process. Moreover, the information might need to be re-entered into the spreadsheet application on a periodic basis (such as when reinsurance agreements need to be renewed or updated).

It would be desirable to provide improved systems and methods to accurately and/or automatically provide a global risk relationship resource model. Moreover, results of the resource model should be easy to access, understand, interpret, update, etc.

### SUMMARY OF THE INVENTION

According to some embodiments, systems, methods, apparatus, computer program code and means are provided to accurately and/or automatically provide a global risk relationship resource model in a way that provides fast and useful results and that allows for flexibility and effectiveness when responding to those results.

Some embodiments are directed to a risk relationship resource model data store that contains electronic records for risk relationship resource models. Each electronic record includes an electronic record identifier, model version identifier, period definition, and layer information. A computer server retrieves, from the data store, information about a risk relationship resource model including the model version identifier, period definition, and layer information. The computer server may then receive, from a remote user device, an adjustment to the risk relationship resource model and execute the model, including an experience rating process and an exposure rating process, to generate a prospective resource amount (based in part on the period definition and the layer information). Information about the adjusted risk relationship resource model, including an updated model version identifier, may then be stored into the data store. The remote user device may support interactive actuarial interface displays that collect, calculate, and provide information (including the prospective resource amount).

Some embodiments comprise: means for retrieving, by a back-end application computer server from a risk relationship resource model data store, information about a risk relationship resource model including a model version identifier, period definition, and layer information, wherein the risk relationship resource model data store contains electronic records associated with risk relationship resource models, each electronic record including an electronic record identifier; mean for receiving, from a remote user device, an adjustment to the risk relationship resource model; means for executing the adjusted risk relationship resource model, including an experience rating process and an exposure rating process, to generate a prospective resource amount based in part on the period definition and the layer information; means for storing, into the risk relationship resource model data store, information about the adjusted risk relationship resource model, including an updated model version identifier; and means for facilitating an exchange of data with the remote user device to support interactive actuarial interface displays that collect, calculate, and provide information, including the prospective resource amount.

In some embodiments, a communication device associated with a back-end application computer server exchanges information with remote devices in connection with interactive graphical user interfaces. The information may be exchanged, for example, via public and/or proprietary communication networks.

A technical effect of some embodiments of the invention is an improved and computerized way to accurately support a global risk relationship resource model in a way that provides fast and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 illustrates a process flow associated with a global risk relationship resource model.

FIG. 2 is a high-level block diagram of a system in accordance with some embodiments.

FIG. 3 illustrates a method according to some embodiments of the present invention.

FIG. 4 is a general information display in accordance with some embodiments.

FIG. 5 is an additional general information display according to some embodiments.

FIG. 6 is a triangles ground-up diagnostic display (paid) display in accordance with some embodiments.

FIG. 7 is an experience rating ground-up trended and on-level claim count display according to some embodiments.

FIG. 8 is an experience rating ground-up trended and on-level level loss dollars display in accordance with some embodiments.

FIG. 9 is an experience rating ground-up nominal claim count display according to some embodiments.

FIG. 10 is an experience rating ground-up nominal loss dollars display in accordance with some embodiments.

FIG. 11 is an experience rating ground-up experience summary display according to some embodiments.

FIG. 12 is a rate changes premium split display in accordance with some embodiments.

FIG. 13 is a rate changes rate change display according to some embodiments.

FIG. 14 is a rate changes policy term display in accordance with some embodiments.

FIG. 15 is an exposure rating limit profile display according to some embodiments.

FIG. 16 is an exposure rating exposure selections display in accordance with some embodiments.

FIG. 17 is an exposure rating using relatives display according to some embodiments.

FIGS. 18A and 18B are selections displays in accordance with some embodiments.

FIG. 19 is a layer distribution display according to some embodiments.

FIG. 20 is a block diagram of an apparatus in accordance with some embodiments of the present invention.

FIG. 21 is a portion of a tabular global reinsurance pricing model data store according to some embodiments.

FIG. 22 is an operator or administrator display in accordance with some embodiments.

FIG. 23 illustrates a tablet computer with a global reinsurance pricing model display according to some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data processing associated with risk relationship resource model. The present invention is directed to more than merely a computer implementation of a routine or conventional activity previously known in the industry as it provides a specific advancement in the area of electronic record analysis by providing improvements in the operation of a computer system that customizes pricing models associated with reinsurance risk relationships. The present invention provides improvement beyond a mere generic computer implementation as it involves the novel ordered combination of system elements and processes to provide improvements in the speed and accuracy of user interface customization tools. Some embodiments of the present invention are directed to a system adapted to automatically customize reinsurance pricing models, utilize information from prior versions of a pricing model, automatically optimize user interactions to reduce unnecessary messages or communications, etc. Moreover, communication links and messages may be automatically established, aggregated, formatted, modified, removed, exchanged, etc. to improve network performance (e.g., by reducing an amount of network messaging bandwidth and/or storage required to determine an appropriate reinsurance premium).

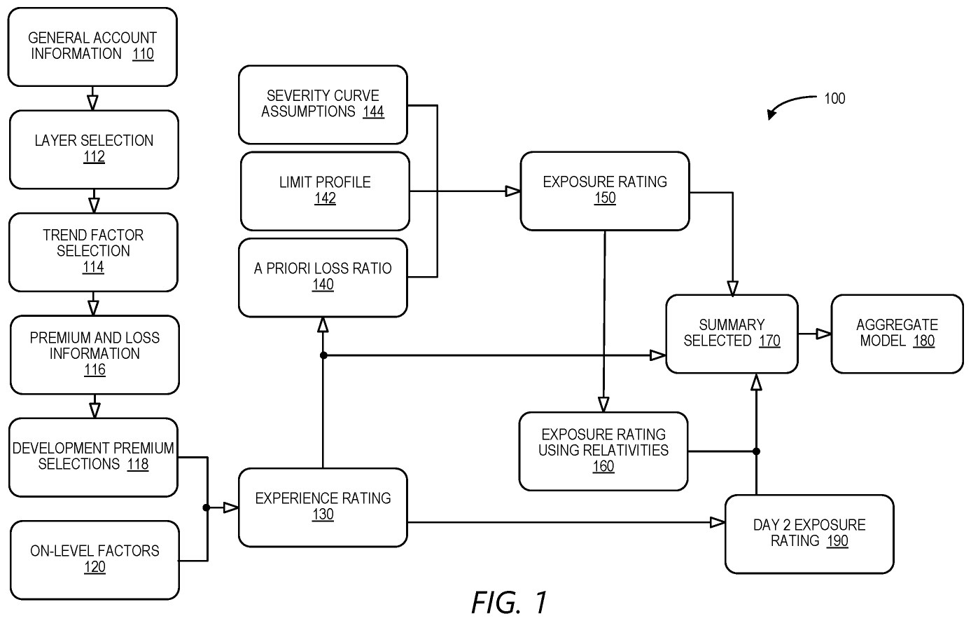

An enterprise may determine a resource amount associated with a risk relationship. For example, FIG. 1 illustrates a process flow 100 to determine an appropriate reinsurance premium associated with a global risk relationship resource model. Initially, general account information 110 is determined and layer selection 112 information may be collected (e.g., five layers of risk might be individually priced). Trend factor selections 114 may utilize benchmarks at a starting point and provide an ability to select and index as appropriate. Premium and loss information 116 is determined in connection with historical periods and evaluation points and development premium selections 118 may be provided to an experience rating 130 process along with on-level factors 120 (e.g., a mix by term, mix by state or product, rate change, etc.).

Information from the experience rating 130 process is provided to an a priori loss ratio 140 that blends ground-up loss ratios with benchmark loss ratios. The a priori loss ratio 140 is provided to an exposure rating 150 process along with a limit profile 142 (e.g., deductible amounts, self-insured retention data, limits, percent of premium, etc.) and severity curve assumptions 144 (e.g., based on a line of business). The exposure rating 150 process to generate summary selected 170 information and an exposure rating using relatives 160 (which is also based on information from the experience rating 130 process). The summary selected 170 information may be further based on a day 2 exposure rating 190 and eventually be used to create an aggregate model 180 for pricing.

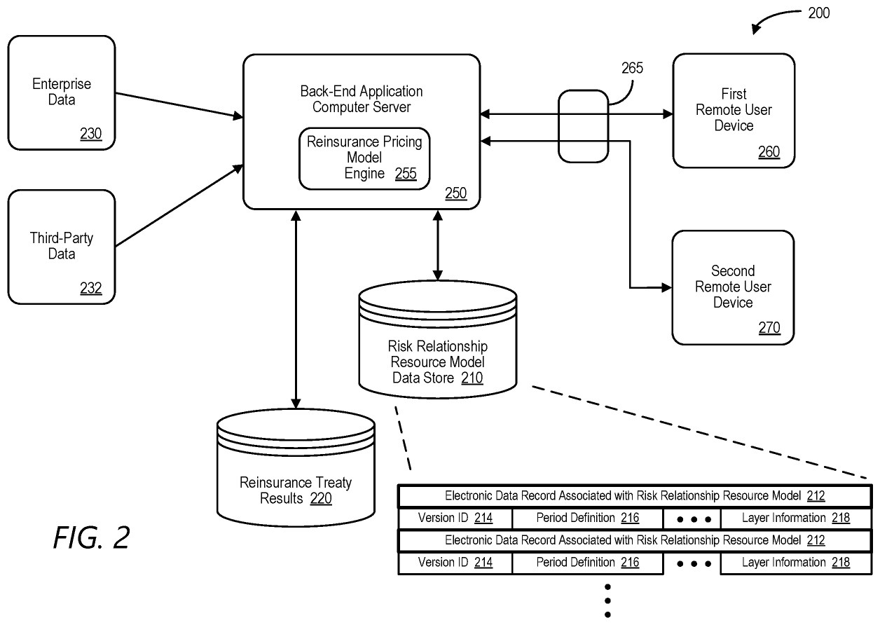

FIG. 2 is a high-level block diagram of a risk relationship resource model system 200 according to some embodiments of the present invention. In particular, the system 200 includes a back-end application computer server 250 that may access information in a risk relationship resource model data store 210 (e.g., storing a set of electronic records associated with risk relationship resource models 212, each record including, for example, one or more version identifiers 214, period definitions 216, layer information 218, etc.). The back-end application computer server 250 may also store information into other data stores, such as reinsurance treaty results 220, and utilize a reinsurance pricing model engine 255 to view, analyze, and/or update the electronic records. The back-end application computer server 250 may also exchange information with a first remote user device 260 (e.g., associated with a first actuarial or other employee of an enterprise) and a second remote user device 270 (e.g., via a firewall 265). According to some embodiments, an interactive graphical user interface platform of the back-end application computer server 250 (and, in some cases, enterprise data 230 of an insurer and/or third-party data 232) may facilitate forecasts, decisions, predictions, and/or the display of results via one or more remote administrator computers (e.g., to identify an appropriate prospective premium) and/or the remote user devices 260, 270. For example, the first remote user device 260 may transmit annotated and/or updated information to the back-end application computer server 250. Based on the updated information, the back-end application computer server 250 may adjust data in the risk relationship resource model data store 210 and/or the reinsurance treaty results 220 and the change may (or may not) be used in connection with the second remote user device 270. Note that the back-end application computer server 250 and/or any of the other devices and methods described herein might be associated with a third party, such as a vendor that performs a service for an enterprise.

The back-end application computer server 250 and/or the other elements of the system 200 might be, for example, associated with a Personal Computer (“PC”), laptop computer, smartphone, an enterprise server, a server farm, and/or a database or similar storage devices. According to some embodiments, an “automated” back-end application computer server 250 (and/or other elements of the system 200) may facilitate the automated access and/or update of electronic records in the reinsurance treaty results 220. As used herein, the term “automated” may refer to, for example, actions that can be performed with little (or no) intervention by a human.

As used herein, devices, including those associated with the back-end application computer server 250 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 250 may store information into and/or retrieve information from the risk relationship resource model data store 210 and/or the reinsurance treaty results 220. The data elements 210, 220 may be locally stored or reside remote from the back-end application computer server 250. As will be described further below, the risk relationship resource model data store 210 may be used by the back-end application computer server 250 in connection with an interactive user interface to access and update electronic records. Although a single back-end application computer server 250 is shown in FIG. 2, any number of such devices may be included. Moreover, various devices described herein might be combined according to embodiments of the present invention. For example, in some embodiments, the back-end application computer server 250 and risk relationship resource model data store 210 might be co-located and/or may comprise a single apparatus.

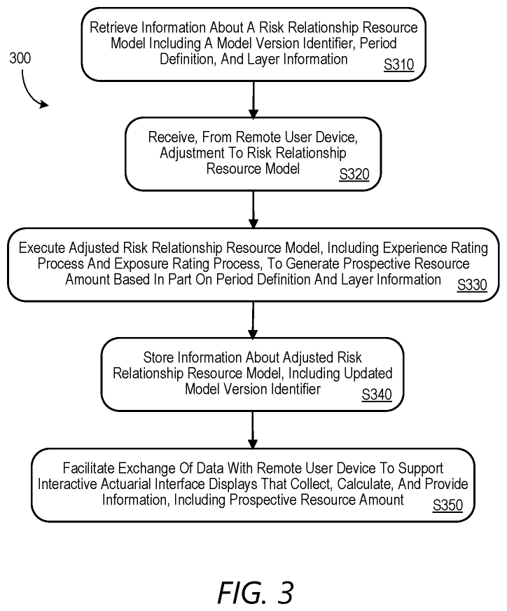

Note that the system 200 of FIG. 2 is provided only as an example, and embodiments may be associated with additional elements or components. According to some embodiments, the elements of the system 200 automatically transmit information associated with an interactive user interface display over a distributed communication network. FIG. 3 illustrates a method 300 that might be performed by some or all of the elements of the system 200 described with respect to FIG. 2, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a back-end application computer server may retrieve, from a risk relationship resource model data store, information about a risk relationship resource model including a model version identifier, period definition, and layer information. The risk relationship resource model data store may, for example, contain electronic records associated with risk relationship resource models (each electronic record may include an electronic record identifier). At S320, an adjustment to the risk relationship resource model is received from a remote user device.

At S330, the system may execute the adjusted risk relationship resource model, including an experience rating process and an exposure rating process, to generate a prospective resource amount based in part on the period definition and the layer information. As used herein, the phrase “exposure rating” may refer a procedure used to calculate risk exposure in a reinsurance treaty. The loss experience of a portfolio of similar, but not identical, risks may be examined to determine potential losses (e.g., when the reinsurer does not have sufficient credible claims history available). Moreover, the phrase “exposure rating” may be associated with an examination of loss experience of a portfolio of similar, but not identical, risks (e.g., assuming that risks in similar risk groups will display similar loss experiences). The result of an exposure rating is an estimation of the expected losses expected as a result of a specific event. The process may express loss as a percentage of the amount of value insured.

At S340, the system may store, into the risk relationship resource model data store, information about the adjusted risk relationship resource model, including an updated model version identifier. For example, if an original pricing model had a version identifier of “1.0” the updated model version identifier might comprise “2.0,” “1.1,” “1.1.1,” etc. At S350, the system may facilitate an exchange of data with the remote user device to support interactive actuarial interface displays that collect, calculate, and provide information, including the prospective resource amount.

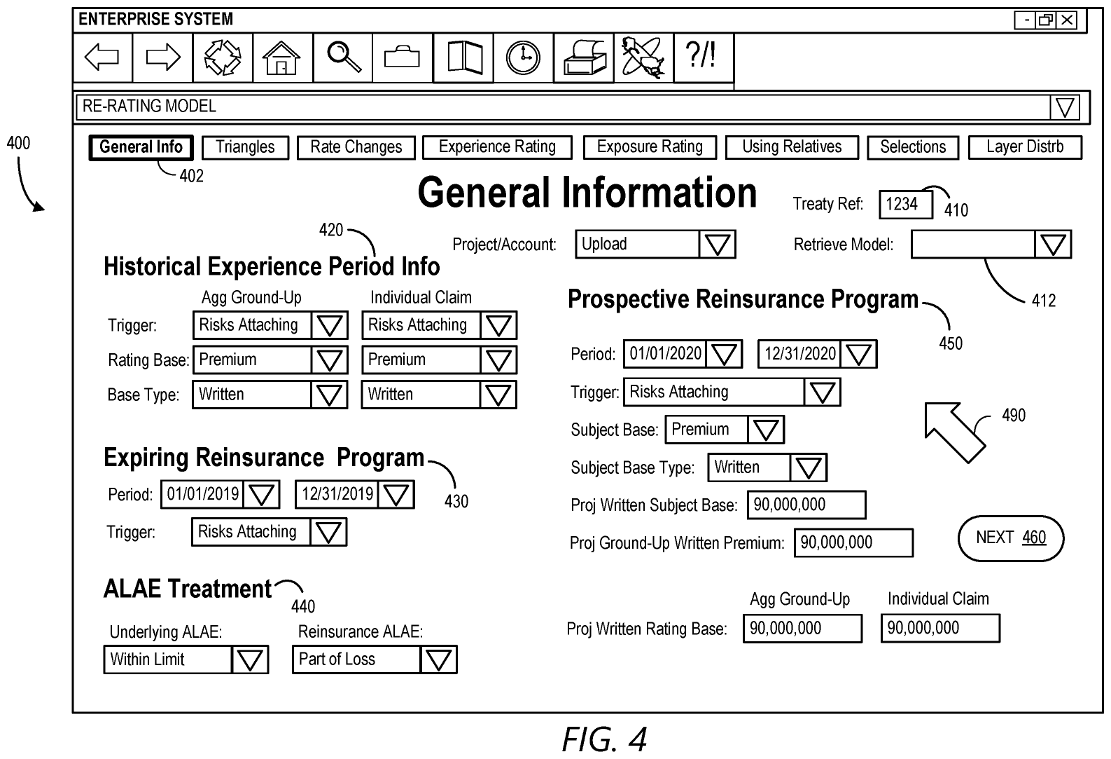

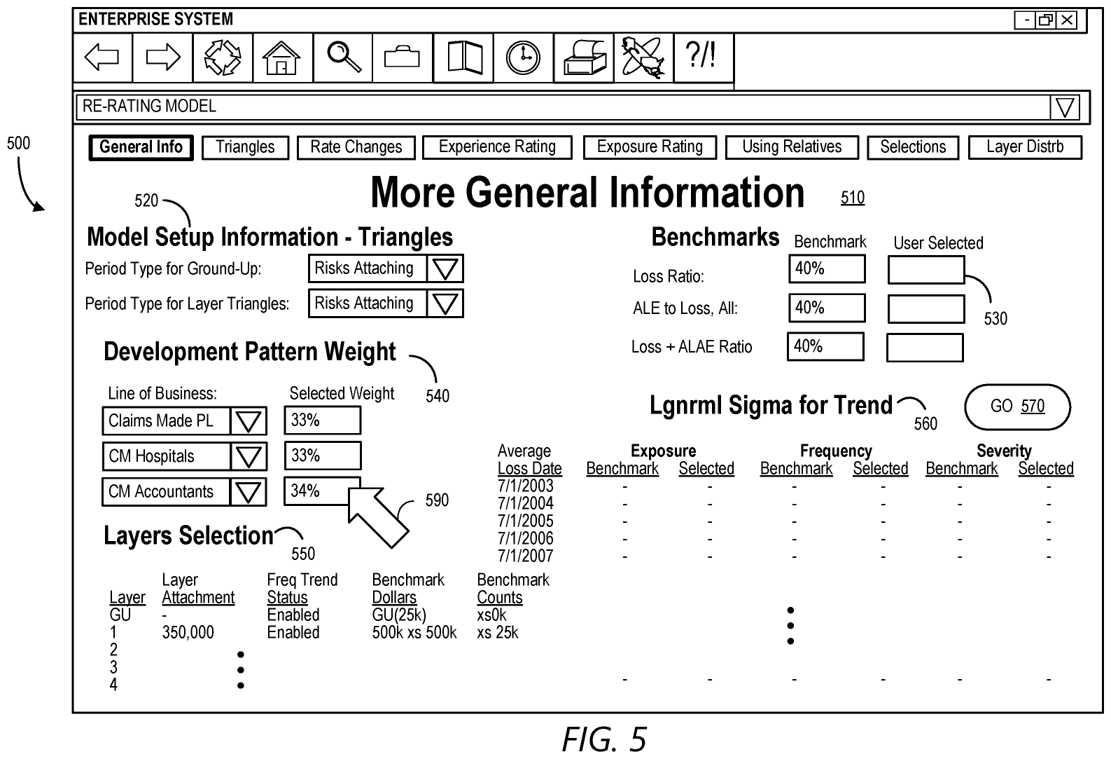

For example, FIG. 4 is a general information interactive actuarial interface display 400 in accordance with some embodiments. An actuarial user may, for example, navigate through the displays described herein in connection with FIGS. 4 through 19 via a menu 402 (e.g., selectable via a touchscreen or computer mouse pointer 490). The display 400 may, for example, collect actuarial information for a specific reinsurance treaty identifier 410 and/or a specific model identifier or version number (e.g., selected from available versions via a drop-down menu 412). The information may include, according to some embodiments, historical experience period information 420, expiring reinsurance program information 430, Allocated Loss Adjustment Expenses (“ALAE”) information 440, prospective reinsurance program information 450, etc. Selection of a “Next” icon 460 may result in navigation to an additional general information display 500 as shown in FIG. 5 that collects further information 510 about the reinsurance treaty. The display 500 may include model setup information 520 (e.g., using a computer mouse pointer 590 to select a period type), benchmark information 530 such as loss ratio, development pattern weights 540 (per line of business), layers selection information 550 (e.g., including, for each layer, a layer attachment, a frequency trend status, benchmark layer amounts, and benchmark count amounts), trend information 560 (including, for a plurality of average loss dates, benchmark and selected exposure trend information, benchmark and selected frequency trend information, and benchmark and selected severity trend information), etc. Selection of a “Go” icon 570 may execute the pricing model.

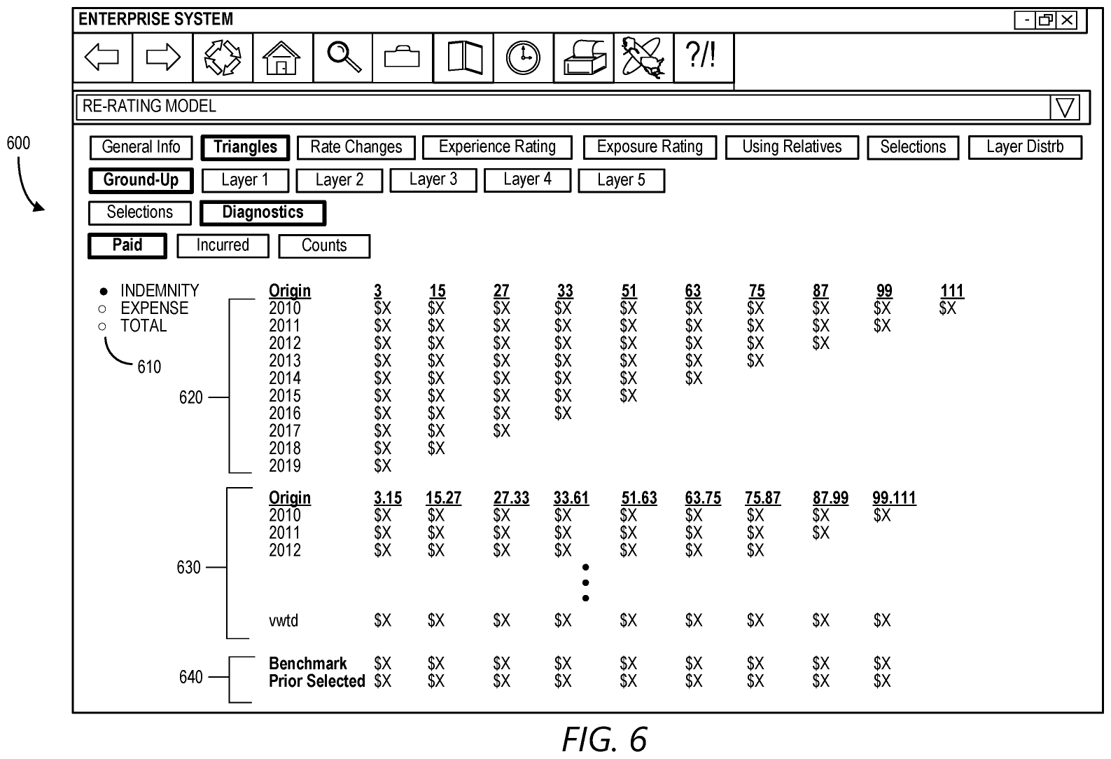

FIG. 6 is a triangles ground-up diagnostics (paid) display 600 in accordance with some embodiments. Note that the display 600 may be adjusted to provide indemnity data, expense data, or total data 610. The display 600 includes, for each of a plurality of origin years 620, 630 dollar amounts and final benchmark and prior selected values 640.

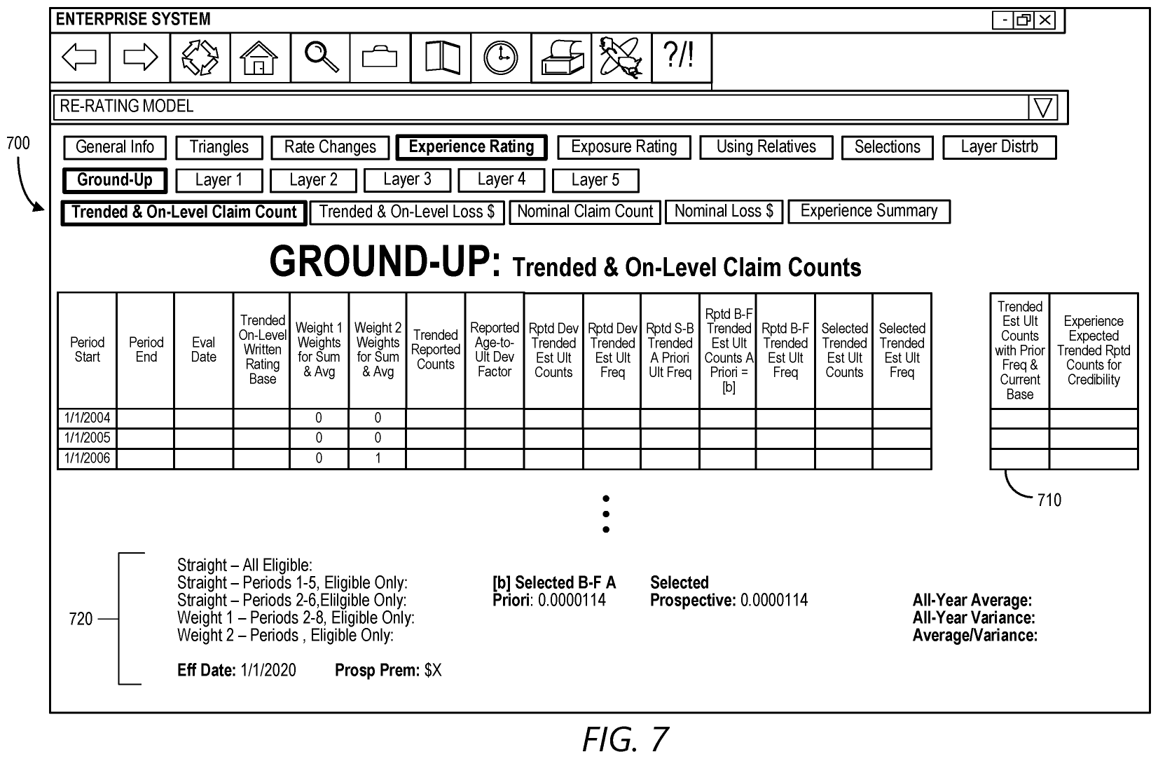

FIG. 7 is an experience rating ground-up trended and on-level claim count display 700 according to some embodiments. The display 700 includes a table 710 with various values, including a plurality of time periods, an evaluation date, a trended on-level written rating base, multiple weights for sums and averages, trended reported counts, selected trended estimated ultimate counts, selected trended estimated ultimate frequency, etc. The display 700 also includes final results 720, such as a prospective reinsurance premium value.

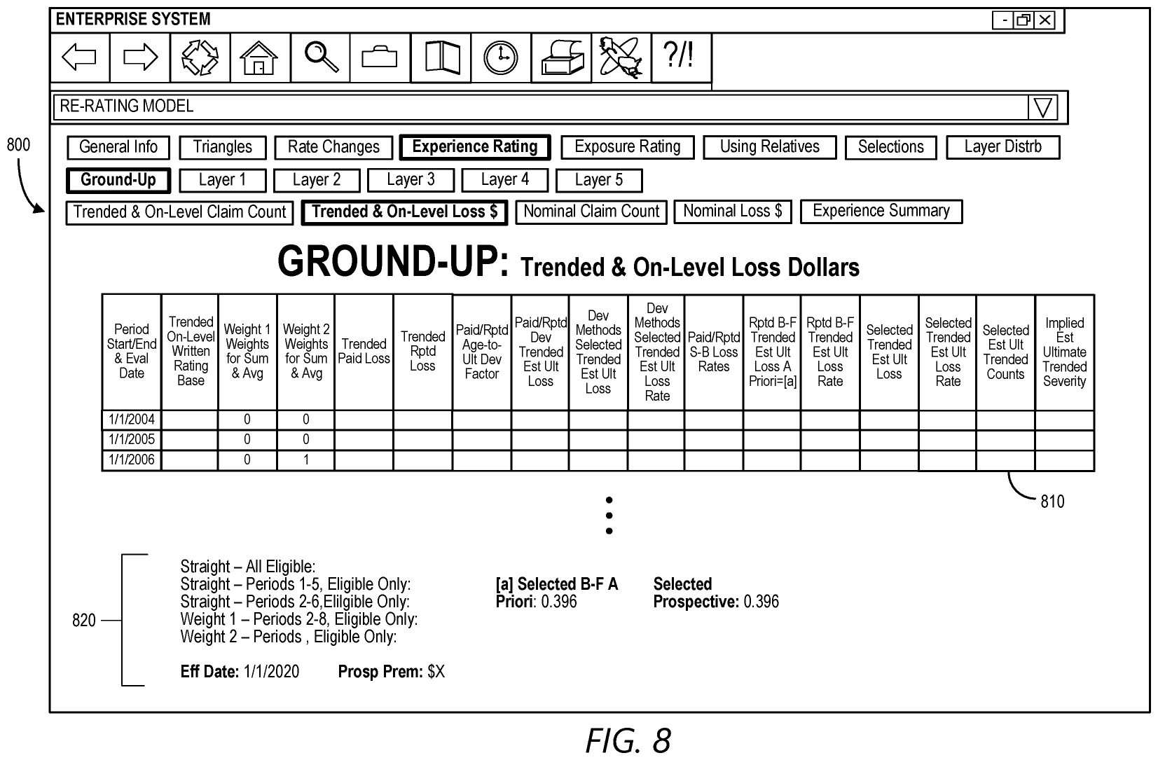

FIG. 8 is an experience rating ground-up trended and on-level level loss dollars display 800 in accordance with some embodiments. The display 800 includes a table 810 with a plurality of values including a plurality of time periods, an evaluation date, a trended on-level written rating base, multiple weights for sums and averages, a trended paid loss, a trended reported loss, a selected trended estimated ultimate loss, selected trended estimated ultimate loss rates, selected estimated ultimate trended counts, an implied estimated ultimate severity, etc. The display 800 also includes final results 820, such as a prospective reinsurance premium value.

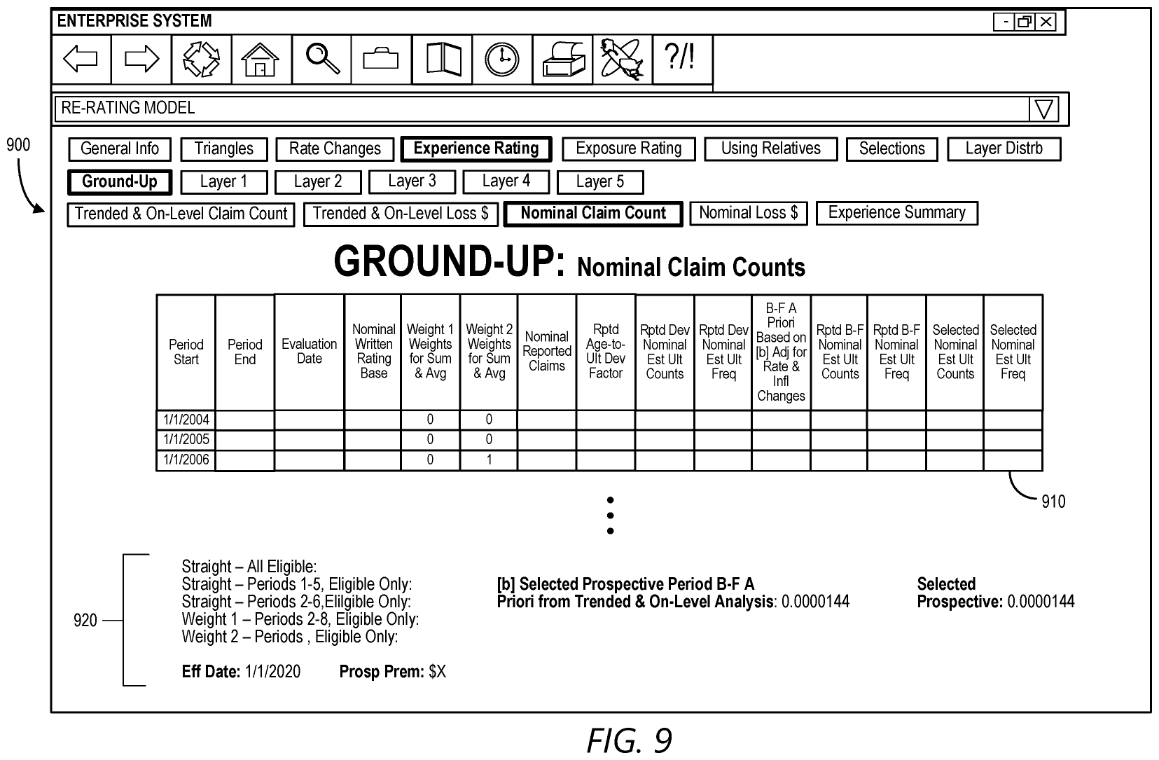

FIG. 9 is an experience rating ground-up nominal claim count display 900 according to some embodiments. The display 900 includes a table 910 with a plurality of values including a plurality of time periods, an evaluation date, a nominal written rating base, multiple weights for sums and averages, nominal reported counts, selected nominal estimated ultimate counts, a selected nominal estimated ultimate frequency, etc. The display 900 also includes final results 920, such as a prospective reinsurance premium value.

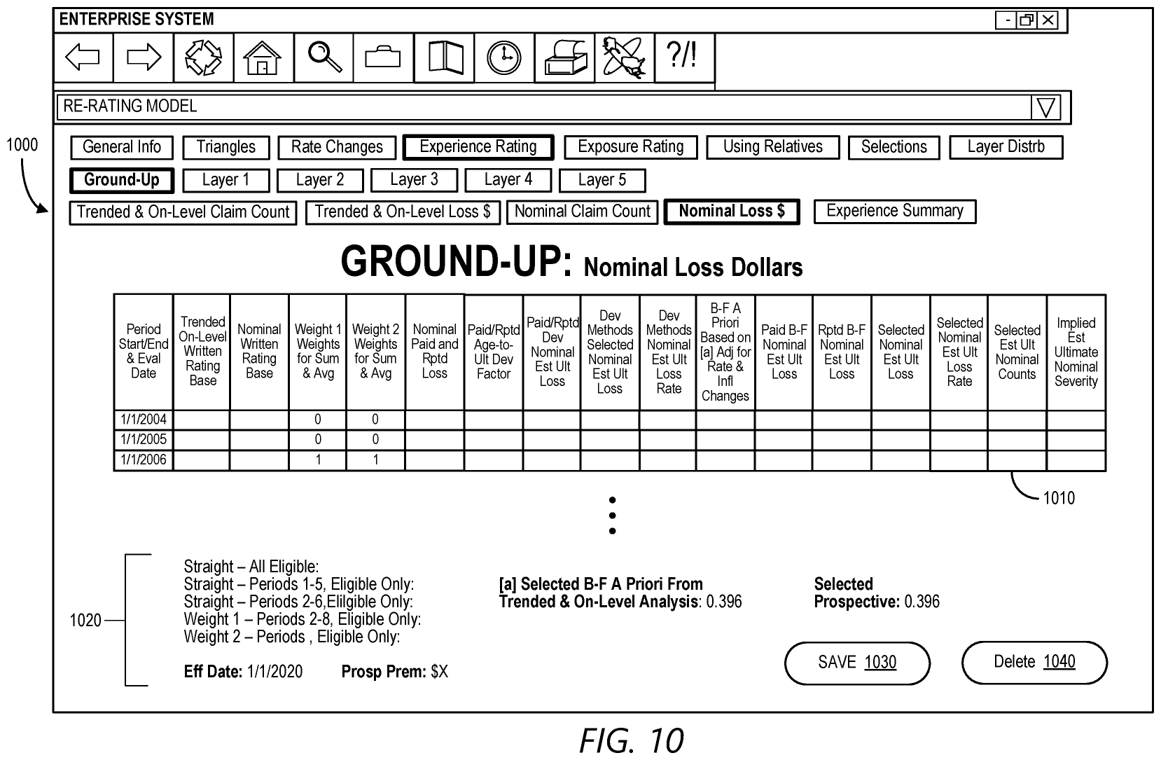

FIG. 10 is an experience rating ground-up nominal loss dollars display 1000 in accordance with some embodiments. The display 1000 includes a table 1010 with a plurality of values including a plurality of time periods, an evaluation date, a nominal written rating base, multiple weights for sums and averages, a nominal paid loss, a nominal reported loss, a selected nominal estimated ultimate loss, a selected nominal estimated ultimate loss rate selected estimated ultimate nominal counts, an implied estimated ultimate nominal severity, etc. The display 1000 also includes final results 1020, such as a prospective reinsurance premium value. Selection of a “Save” icon 1030 may result in the pricing model values being stored (and selection of a “Delete” icon 1040 may erase the pricing model).

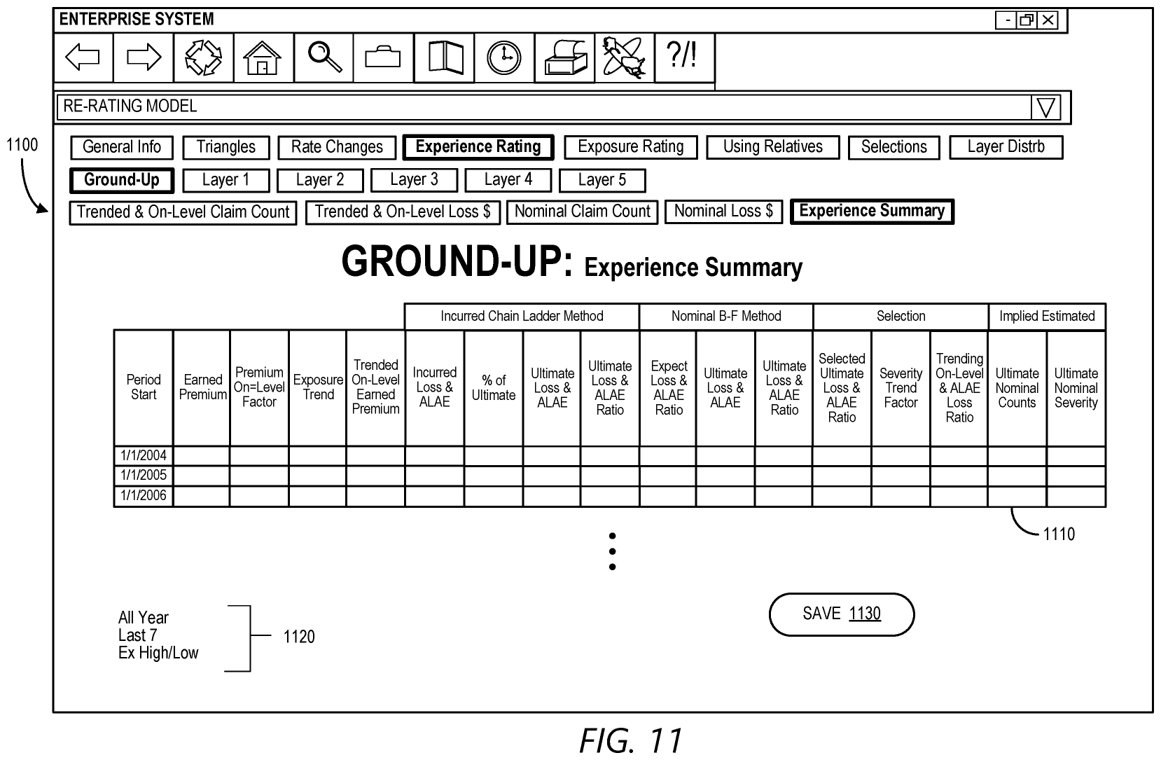

FIG. 11 is an experience rating ground-up experience summary display 1100 according to some embodiments. The display 1100 includes a table 1110 with a plurality of values including (for a plurality of periods) an earned premium, a premium on-level factor, an exposure trend, a trended on-level earned premium, incurred ladder method values, nominal BF method values, selection values, implied estimated values, etc. The display 1100 also includes calculated values 1120 for all years and the last seven years. Selection of a “Save” icon 1130 may result in the pricing model values being stored.

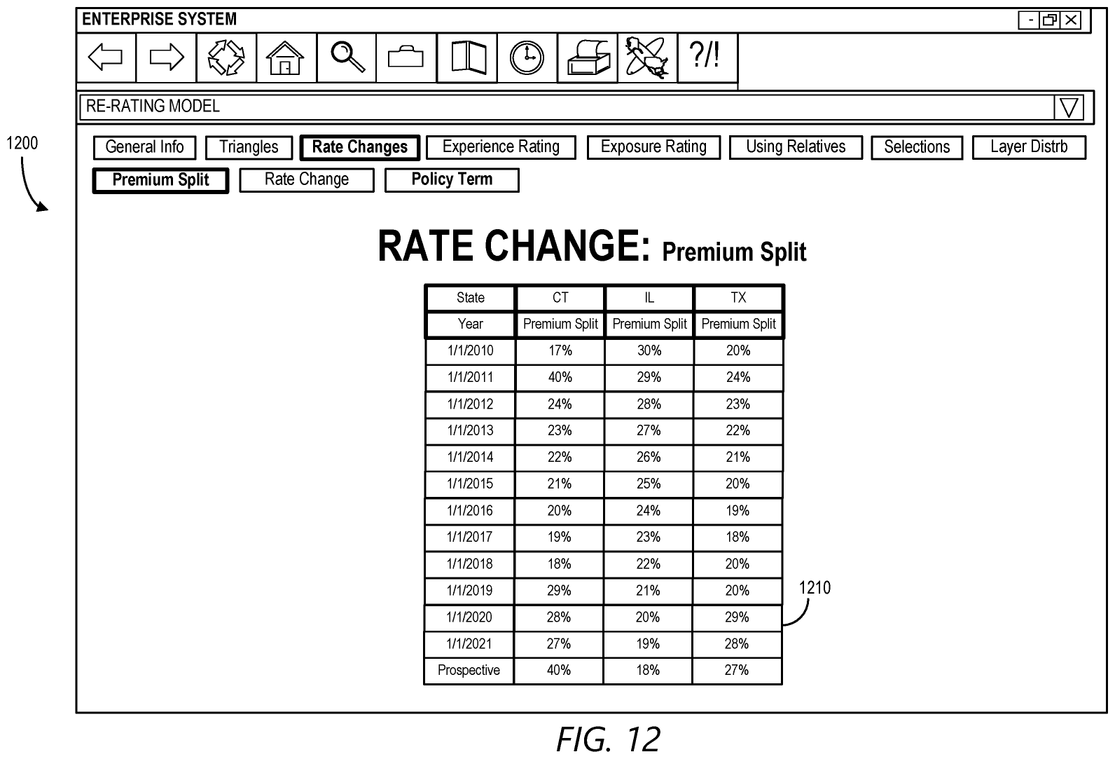

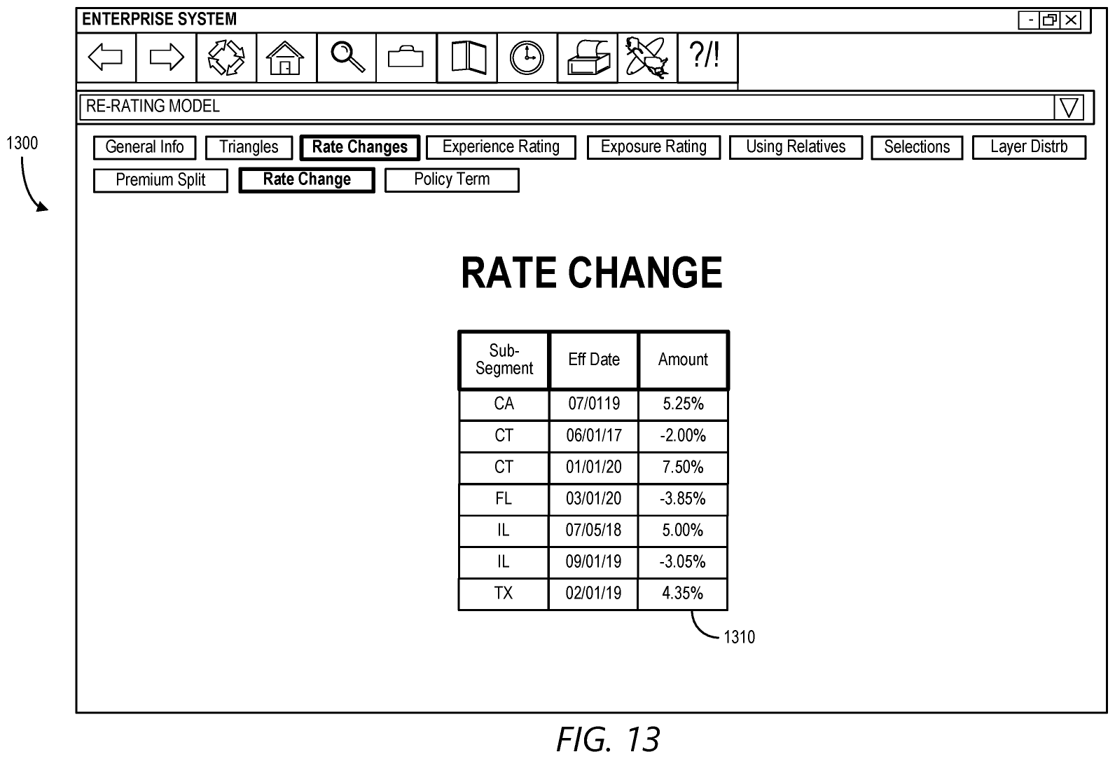

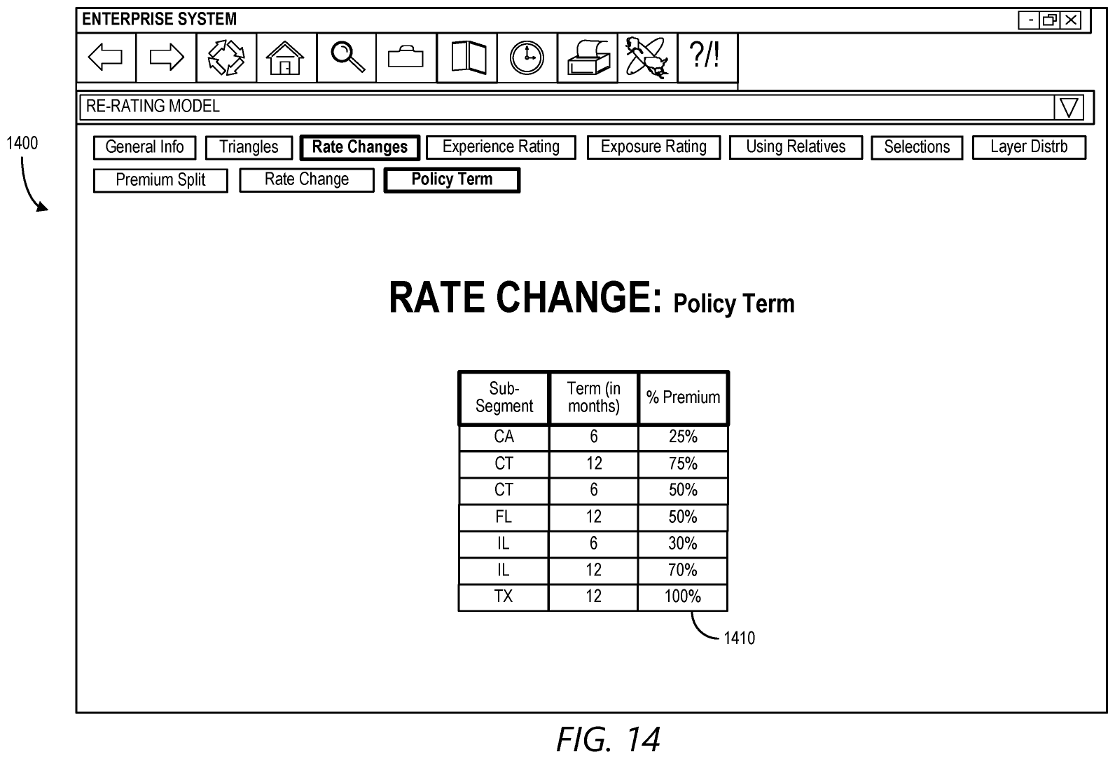

FIG. 12 is a rate changes premium split display 1200 in accordance with some embodiments. The display 1200 includes a table 1210 that indicates, for each of a plurality of years (and a prospective value), how a reinsurance premium might be split among multiple states (e.g., Connecticut (“CT”), Illinois (“IL”), and Texas (“TX”)). FIG. 13 is a rate changes rate change display 1300 according to some embodiments. The display 1300 includes a table 1310 indicating, for each of a plurality of sub-segments, an effective date and a rate change amount. FIG. 14 is a rate changes policy term display 1400 in accordance with some embodiments. The display 1400 includes a table 1410 indicating, for each of a plurality of sub-segments, a term (in months) and a premium percentage.

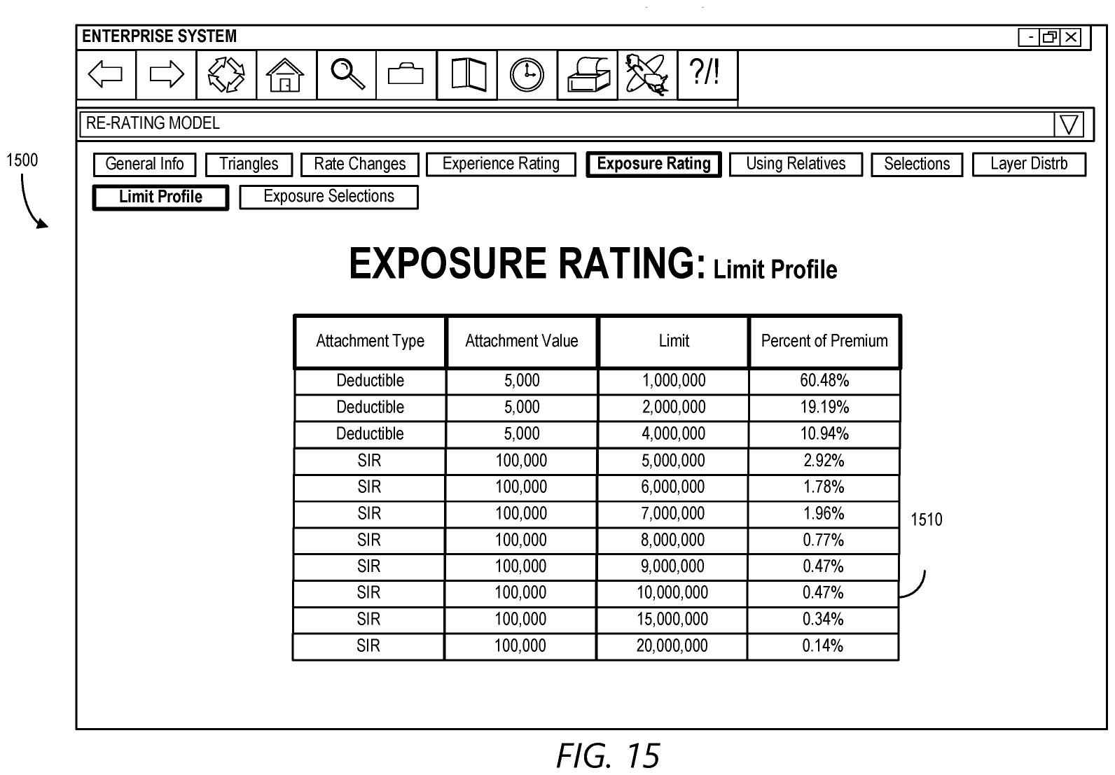

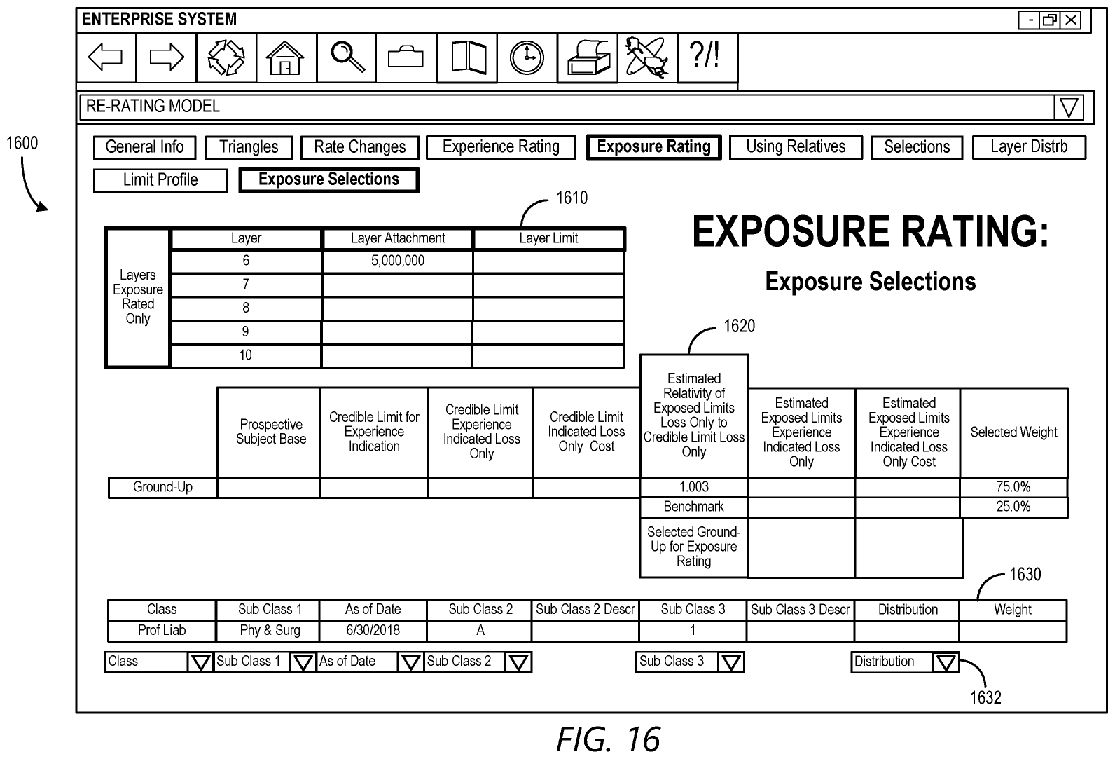

FIG. 15 is an exposure rating limit profile display 1500 according to some embodiments. The display 1500 includes a table 1510 that indicates, for various attachment types (e.g., deductible or Self-Insured Retention (“SIR”)) and attachment values a limit amount of a percent of premium value. FIG. 16 is an exposure rating exposure selections display 1600 in accordance with some embodiments. The display includes a first table 1610 that indicates, for each of a plurality of layers, a layer attachment and a layer limit. A second table 1620 indicates, for ground-up, a prospective subject base, a credible limit for experience indication, a credible limit experience indicated loss only, a credible limit indicated loss only cost, an estimated relativity of exposed limits loss only to credible limit loss only, a selected weight, benchmark information, selected ground-up for exposure rating values, etc. A third table 1630 indicates, for various classes, sub-class information, a distribution curve type, etc. (which may be selectable via drop-down menus 1632).

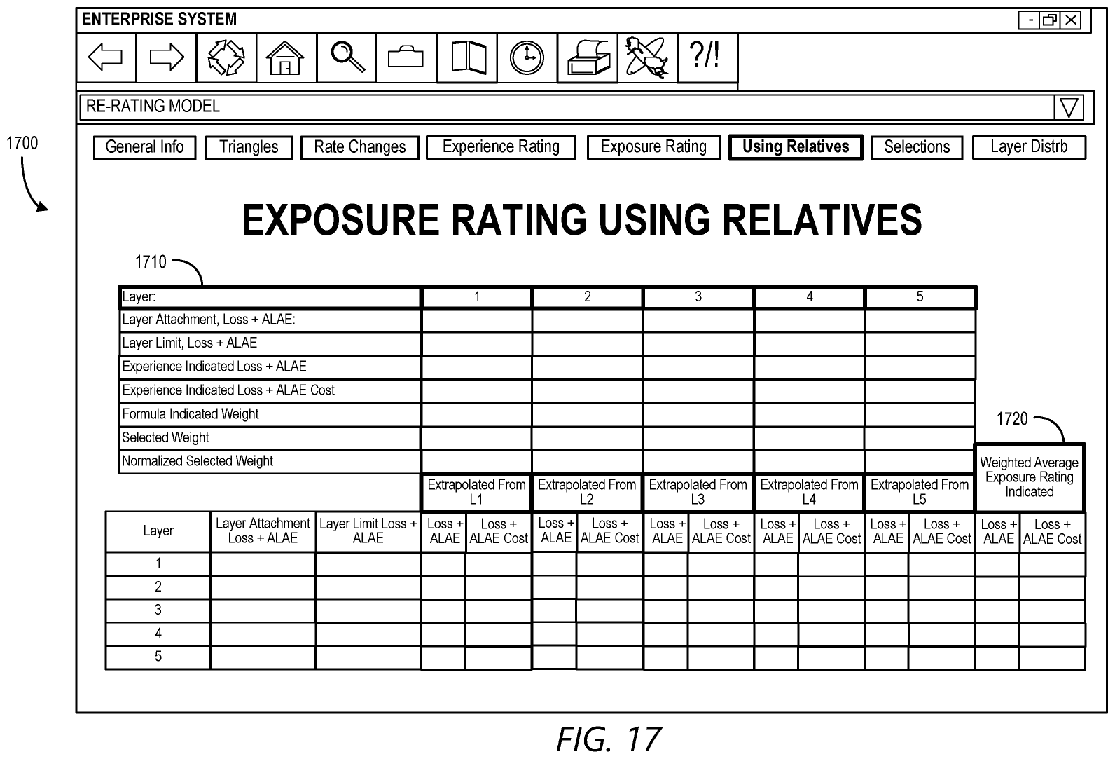

FIG. 17 is an exposure rating using relatives display 1700 according to some embodiments. The display 1700 includes a first table 1710 that indicates, for each of a plurality of layers, layer attachment, loss, and ALAE values, layer limit, loss, and ALE values, experience indicated loss and ALAE values, experience indicated loss and ALAE cost values, formula indicated weights, selected weights, normalized selected weights, information extrapolated from various layers experience indicated, etc. The display 1700 also includes a second table 1720 that indicates, for each of a plurality of layers, a weighted average exposure rating indicated, etc.

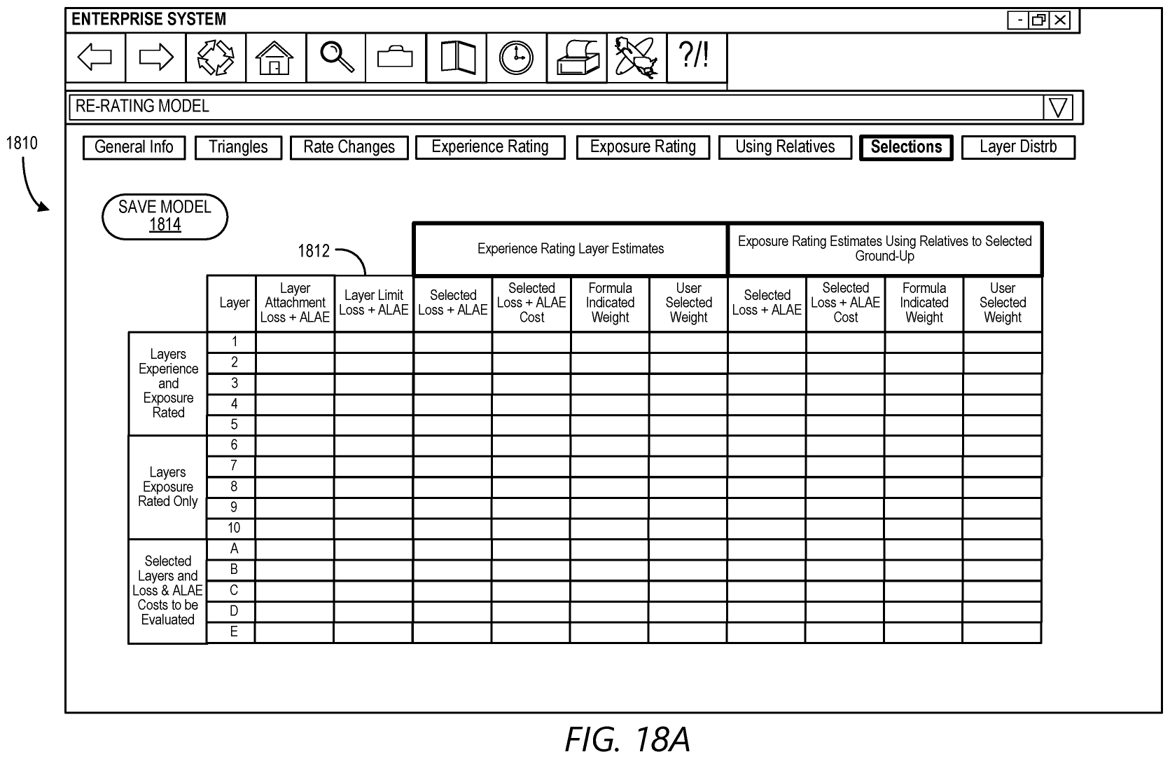

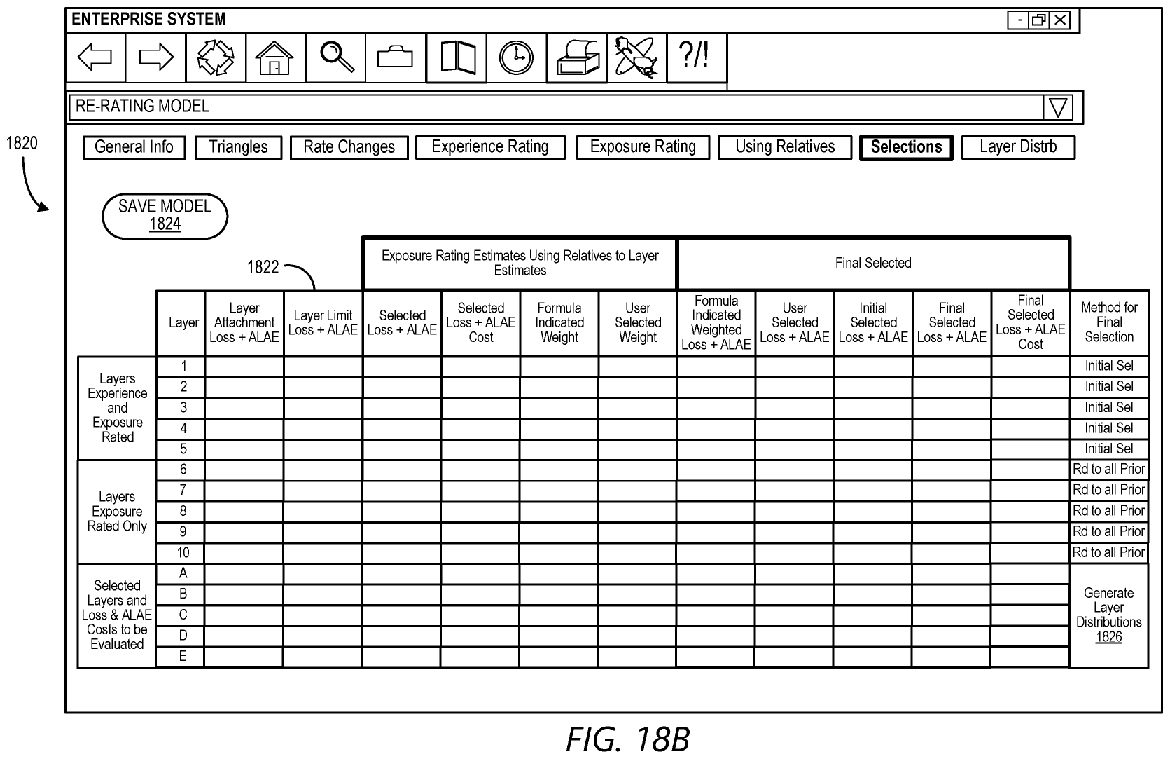

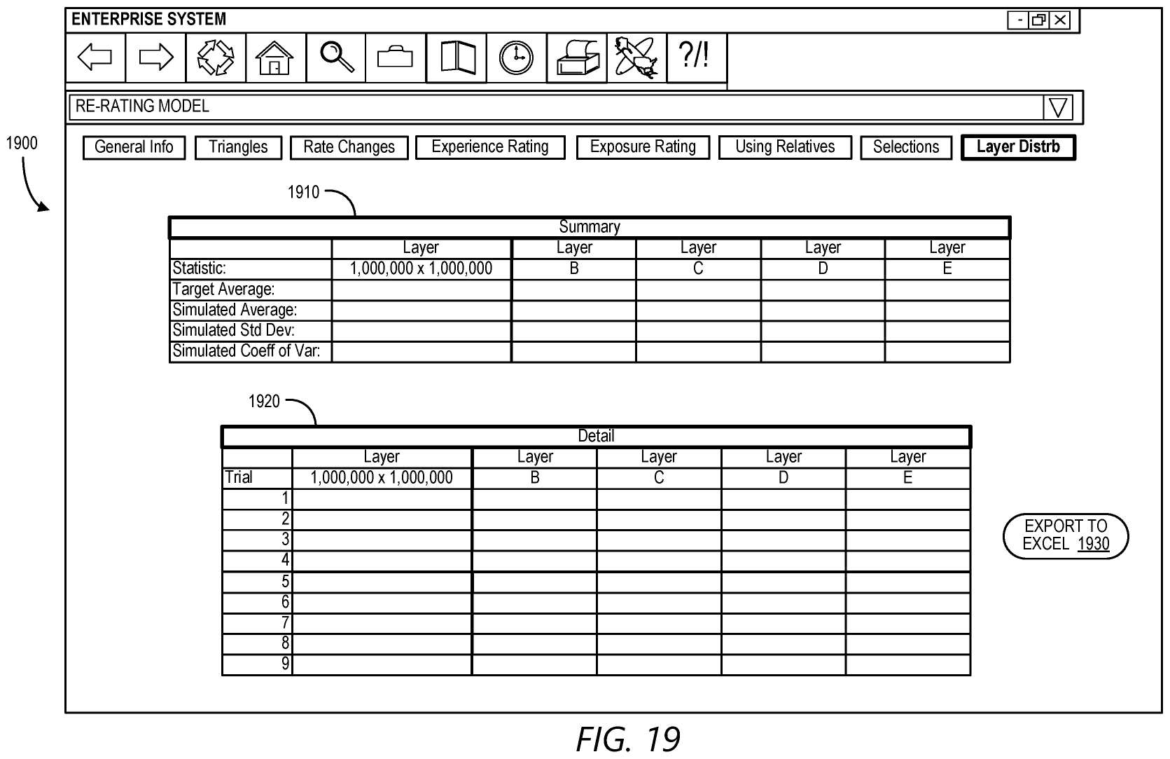

FIG. 18A is a first portion of a selections display 1810 in accordance with some embodiments. The display 1810 includes a table 1812 that indicates, for a plurality of layers, layer attachment loss and ALAE values, layer limit loss and ALAE values, experience rating layer estimates, and exposure rating estimates using relatives to selected group-up values, etc. Selection of a “Save” icon 1814 may result in the pricing model values being stored. FIG. 18B is a second portion of a selections display 1820 in accordance with some embodiments. The display 1820 includes a table 1822 that indicates, for a plurality of layers, exposure rating estimates using relatives to layer estimates, final selected values, a method for final selection, etc. Selection of a “Save” icon 1824 may result in the pricing model values being stored. Selection of a “Generate Layer Distributions” icon 1826 may result in the creation of distribution values for each layer. For example, FIG. 19 is a layer distribution display 1900 according to some embodiments. The display 1900 includes a first table 1910 that indicates, for each of a plurality of layers, a target average, a simulated average, a simulated standard deviation, a simulated coefficient of variance, etc. A second table 1920 indicates, for each of a plurality of trials, layer values, etc. Selection of an “Export to EXCEL®” icon 1930 may result in the values of the display 1900 being saved as an “.xls” file.

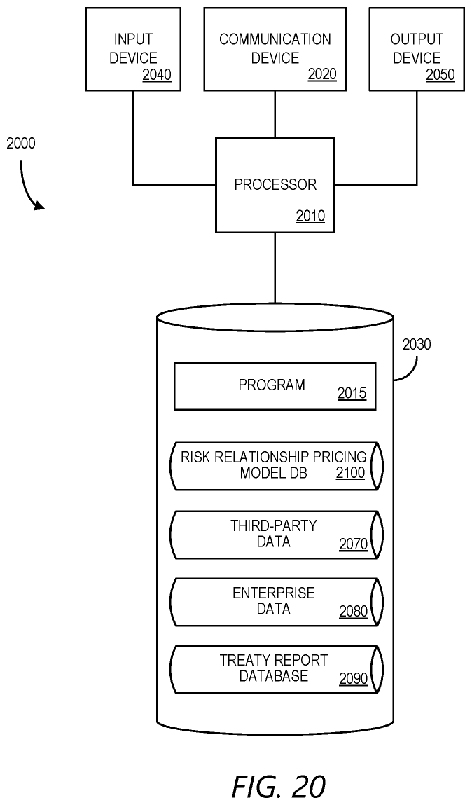

The embodiments described herein may be implemented using any number of different hardware configurations. For example, FIG. 20 illustrates an apparatus 2000 that may be, for example, associated with the system 200 described with respect to FIG. 2. The apparatus 2000 comprises a processor 2010, such as one or more commercially available Central Processing Units (“CPUs”) in the form of one-chip microprocessors, coupled to a communication device 2020 configured to communicate via a communication network (not shown in FIG. 20). The communication device 2020 may be used to communicate, for example, with one or more remote third-party business or economic platforms, administrator computers, and/or communication devices (e.g., PCs and smartphones). Note that communications exchanged via the communication device 2020 may utilize security features, such as those between a public internet user and an internal network of an insurance company and/or an enterprise. The security features might be associated with, for example, web servers, firewalls, and/or PCI infrastructure. The apparatus 2000 further includes an input device 2040 (e.g., a mouse and/or keyboard to enter information about data sources, risk relationship resource model rules or preferences, third-parties, etc.) and an output device 2050 (e.g., to output reports regarding user risk relationship resource models, treaty values, alerts, etc.).

The processor 2010 also communicates with a storage device 2030. The storage device 2030 may comprise any appropriate information storage device, including combinations of magnetic storage devices (e.g., a hard disk drive), optical storage devices, mobile telephones, and/or semiconductor memory devices. The storage device 2030 stores a program 2015 and/or a reinsurance pricing tool or application for controlling the processor 2010. The processor 2010 performs instructions of the program 2015, and thereby operates in accordance with any of the embodiments described herein. For example, the processor 2010 may retrieve information about a risk relationship resource model including the model version identifier, period definition, and layer information. The processor 2010 may then receive, from a remote user device, an adjustment to the risk relationship resource model and execute the model, including an experience rating process and an exposure rating process, to generate a prospective resource amount (based in part on the period definition and the layer information). Information about the adjusted risk relationship resource model, including an updated model version identifier, may then be stored by the processor 2010. The processor 2010 may support interactive actuarial interface displays that collect, calculate, and provide information (including the prospective resource amount).

The program 2015 may be stored in a compressed, uncompiled and/or encrypted format. The program 2015 may furthermore include other program elements, such as an operating system, a database management system, and/or device drivers used by the processor 2010 to interface with peripheral devices.

As used herein, information may be “received” by or “transmitted” to, for example: (i) the apparatus 2000 from another device; or (ii) a software application or module within the apparatus 2000 from another software application, module, or any other source.

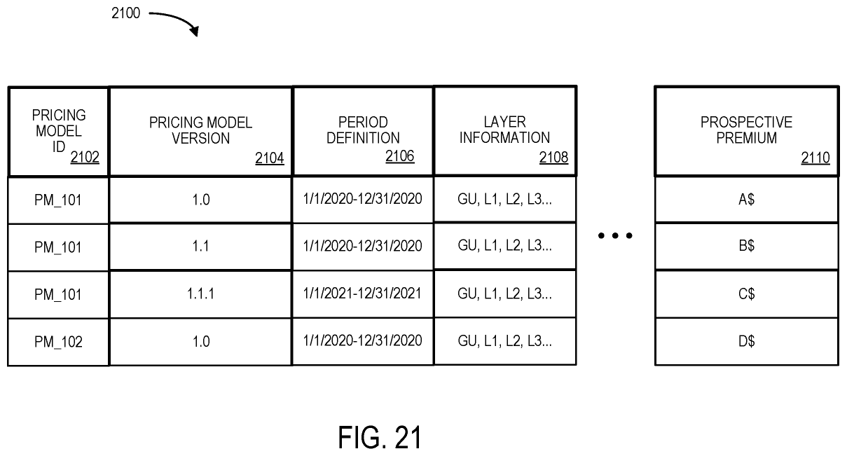

In some embodiments (such as shown in FIG. 20), the storage device 2030 further stores a risk relationship pricing model database 2100, third-party data 2070 (e.g., with third-party user available from public databases), enterprise data 2080 (e.g., regarding insurance policies, claims history, etc.), and a treaty report database 2090. An example of a database that might be used in connection with the apparatus 2000 will now be described in detail with respect to FIG. 21. Note that the database described herein is only an example, and additional and/or different information may be stored therein. Moreover, various databases might be split or combined in accordance with any of the embodiments described herein. For example, the enterprise data 2080 and treaty report database 2090 might be combined and/or linked to each other within the program 2015.

Referring to FIG. 21, a table is shown that represents the risk relationship pricing model database 2100 that may be stored at the apparatus 2000 according to some embodiments. The table may include, for example, entries associated with reinsurance pricing model. The table may also define fields 2102, 2104, 2106, 2108, 2110 for each of the entries. The fields 2102, 2104, 2106, 2108, 2110 may, according to some embodiments, specify: a pricing model identifier 2102, a pricing model version 2104, a period definition 2106, layer information 2108, and a prospective premium 2110. The risk relationship pricing model database 2100 may be created and updated, for example, based on information electrically received from various operators, administrators, and computer systems (e.g., including when a new pricing model is created or when an existing pricing model is adjusted) that may be associated with an insurer.

The pricing model identifier 2102 may be, for example, a unique alphanumeric code identifying a reinsurance pricing model. The pricing model version 2104 might indicate an updated version of the reinsurance pricing model. The period definition 2106 may indicate a period of time (e.g., from a start date to an end date). The layer information 2108 may define, for example, layer attachments, frequency trend status, benchmark dollars, benchmark counts, etc. The prospective premium 2110 may indicate an appropriate reinsurance premium dollar value generated by the pricing model.

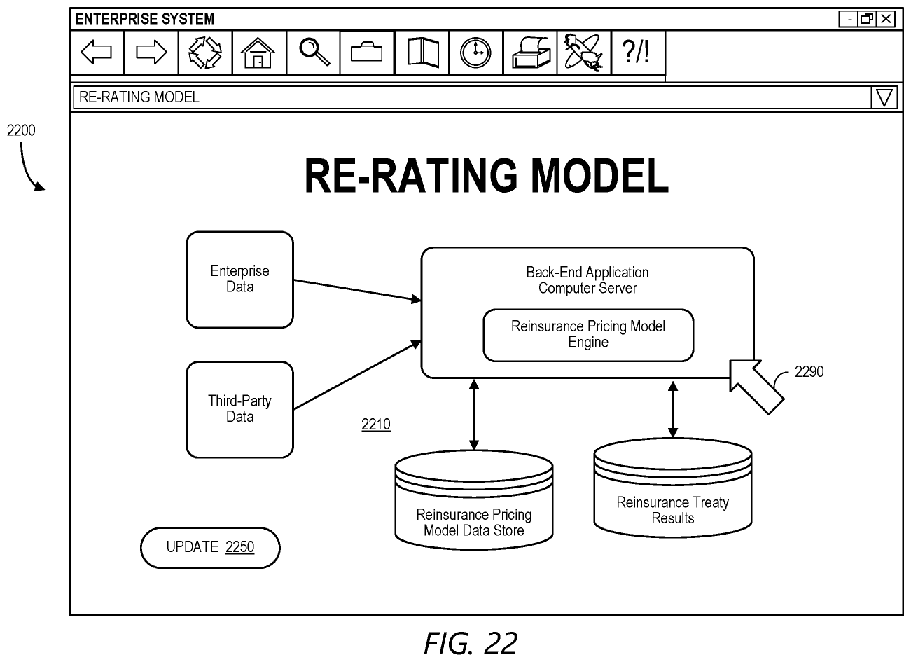

The operation of the risk relationship resource model system may be controlled via a Graphical User Interface (“GUI”). For example, FIG. 22 is a risk relationship resource model display 2200 including graphical representations of elements of a reinsurance pricing model system 2210 according to some embodiments. Selection of a portion or element of the display 2200 might result in the presentation of additional information about that portion or element (e.g., a popup window presenting a data source or result table) or let an operator or administrator enter or annotate additional information about resource allocations (e.g., based on his or her experience and expertise). Selection of an “Update” icon 2250 (e.g., by touchscreen or computer mouse pointer 2290) might cause the pricing model system 2210 or platform to be re-configured.

Thus, embodiments may provide an automated and efficient way to create and utilize a reinsurance pricing model. Such an approach may improve the accuracy of treaty premiums, reduce the amount of time required to generate pricing information (e.g., using information associated with previously saved pricing models), reduce the number of messages that are transmitted via the network, etc.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., the databases described herein may be combined or stored in external systems). Moreover, although embodiments have been described with respect to specific types of enterprises and reinsurance treaties, embodiments may instead be associated with other types of enterprises and reinsurance treaties in additional to and/or instead of those described herein. Similarly, although certain types of insurance and user parameters were described in connection some embodiments herein, other types of insurance products and/or user parameters might be used instead.

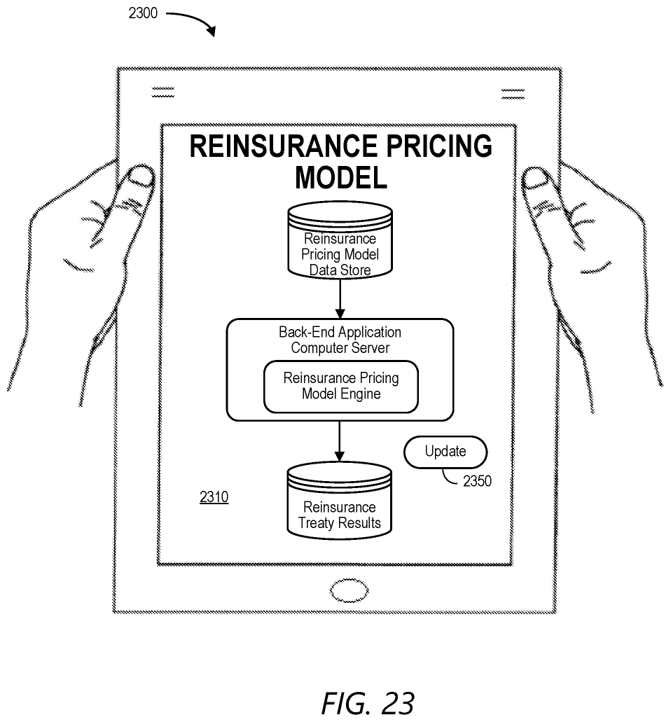

Note that the displays and devices illustrated herein are only provided as examples, and embodiments may be associated with any other types of user interfaces. For example, FIG. 23 illustrates a handheld tablet computer 2300 with a risk relationship resource model display 2310 according to some embodiments. The risk relationship resource model display 2310 shows elements of a system that might include selectable data that can be modified by a user of the tablet computer 2300 (e.g., via an “Update” icon 2350) to view updated risk relationship resource model configurations associated with an enterprise (e.g., including, in some embodiments, details about a reinsurance pricing model engine).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed is:

1. A risk relationship resource model system implemented via a back-end application computer server, comprising:
(a) a risk relationship resource model data store that contains electronic records associated with risk relationship resource models, each electronic record including an electronic record identifier, model version identifier, period definition, and layer information;
(b) the back-end application computer server, coupled to the risk relationship resource model data store, to:
(i) retrieve, from the risk relationship resource model data store, information about a risk relationship resource model including the model version identifier, period definition, and layer information,
(ii) receive, from a remote user device, an adjustment to the risk relationship resource model,
(iii) execute the adjusted risk relationship resource model, including an experience rating process and an exposure rating process, to generate a prospective resource amount based in part on the period definition and the layer information, and
(iv) store, into the risk relationship resource model data store, information about the adjusted risk relationship resource model, including an updated model version identifier; and
(c) a communication port coupled to the back-end application computer server to facilitate an exchange of data with the remote user device to support interactive actuarial interface displays that collect, calculate, and provide information, including the prospective resource amount.

2. The system of claim 1, wherein the risk relationship resource model is a reinsurance pricing model and the prospective resource amount comprises a prospective premium.

3. The system of claim 2, wherein the information in the risk relationship resource model data store includes at least one of: (i) a reinsurance treaty identifier, (ii) historical experience period information, (iii) expiring reinsurance program information, (iv) allocated loss adjustment expenses information, (v) prospective reinsurance program information, (vi) model setup information, (vii) development pattern weights, (viii) layers selection information, and (ix) benchmark information.

4. The system of claim 2, wherein the layer information includes at least one of: (i) a layer attachment, (ii) a frequency trend status, (iii) benchmark layer amounts, and (iv) benchmark count amounts.

5. The system of claim 2, wherein the information in the risk relationship resource model data store includes, for a plurality of average loss dates, at least one of: (i) benchmark exposure trend information, (ii) user selected exposure trend information, (iii) benchmark frequency trend information, (iv) user selected frequency trend information, (v) benchmark severity trend information, and (xi) user selected severity trend information.

6. The system of claim 2, wherein the interactive actuarial interface displays provide calculated experience rating information for trended and on-level claim count data, including at least one of: (i) a plurality of time periods, (ii) an evaluation date, (iii) a trended on-level written rating base, (iv) multiple weights for sums and averages, (v) trended reported counts, (vi) selected trended estimated ultimate counts, and (vii) selected trended estimated ultimate frequency.

7. The system of claim 2, wherein the interactive actuarial interface displays provide calculated experience rating information for trended and on-level loss dollar data, including at least one of: (i) a plurality of time periods, (ii) an evaluation date, (iii) a trended on-level written rating base, (iv) multiple weights for sums and averages, (v) a trended paid loss, (vi) a trended reported loss, (vii) a selected trended estimated ultimate loss, (viii) selected trended estimated ultimate loss rates, (ix) selected estimated ultimate trended counts, and (x) an implied estimated ultimate severity.

8. The system of claim 2, wherein the interactive actuarial interface displays provide calculated experience rating information for nominal claim count data, including at least one of: (i) a plurality of time periods, (ii) an evaluation date, (iii) a nominal written rating base, (iv) multiple weights for sums and averages, (v) nominal reported counts, (vi) selected nominal estimated ultimate counts, and (vii) a selected nominal estimated ultimate frequency.

9. The system of claim 2, wherein the interactive actuarial interface displays provide calculated experience rating information for nominal loss dollar data, including at least one of: (i) a plurality of time periods, (ii) an evaluation date, (iii) a nominal written rating base, (iv) multiple weights for sums and averages, (v) a nominal paid loss, (vi) a nominal reported loss, (vii) a selected nominal estimated ultimate loss, (viii) a selected nominal estimated ultimate loss rate (ix) selected estimated ultimate nominal counts, and (x) an implied estimated ultimate nominal severity.

10. The system of claim 2, wherein the interactive actuarial interface displays provide calculated experience rating summary information, including at least one of: (i) an earned premium, (ii) a premium on-level factor, (iii) an exposure trend, (iv) a trended on-level earned premium, (v) incurred ladder method values, (vi) nominal BF method values, (vii) selection values, and (viii) implied estimated values.

11. The system of claim 2, wherein the interactive actuarial interface displays provide calculated exposure rating information for limit profile data, including at least one of: (i) an attachment type, (ii) an attachment value, (iii) a limit value, and (iv) a percent of premium value.

12. The system of claim 2, wherein the interactive actuarial interface displays provide calculated exposure rating information, including at least one of: (i) layers exposure rated only values, (ii) a prospective subject base, (iii) a credible limit for experience indication, (iv) a credible limit experience indicated loss only, (v) a credible limit indicated loss only cost, (vi) an estimated relativity of exposed limits loss only to credible limit loss only, (vii) class and sub-class information, and (viii) a distribution curve type.

13. A computerized risk relationship resource model method implemented via a back-end application computer server, comprising:
retrieving, by the back-end application computer server from a risk relationship resource model data store, information about a risk relationship resource model including a model version identifier, period definition, and layer information, wherein the risk relationship resource model data store contains electronic records associated with risk relationship resource models, each electronic record including an electronic record identifier;
receiving, from a remote user device, an adjustment to the risk relationship resource model;
executing the adjusted risk relationship resource model, including an experience rating process and an exposure rating process, to generate a prospective resource amount based in part on the period definition and the layer information;
storing, into the risk relationship resource model data store, information about the adjusted risk relationship resource model, including an updated model version identifier; and
facilitating an exchange of data with the remote user device to support interactive actuarial interface displays that collect, calculate, and provide information, including the prospective resource amount.

14. The method of claim 13, wherein the risk relationship resource model is a reinsurance pricing model and the prospective resource amount comprises a prospective premium.

15. The method of claim 14, wherein the information in the risk relationship resource model data store includes at least one of: (i) a reinsurance treaty identifier, (ii) historical experience period information, (iii) expiring reinsurance program information, (iv) allocated loss adjustment expenses information, (v) prospective reinsurance program information, (vi) model setup information, (vii) development pattern weights, (viii) layers selection information, and (ix) benchmark information.

16. The method of claim 14, wherein the layer information includes at least one of: (i) a layer attachment, (ii) a frequency trend status, (iii) benchmark layer amounts, and (iv) benchmark count amounts.

17. The method of claim 14, wherein the information in the risk relationship resource model data store includes, for a plurality of average loss dates, at least one of: (i) benchmark exposure trend information, (ii) user selected exposure trend information, (iii) benchmark frequency trend information, (iv) user selected frequency trend information, (v) benchmark severity trend information, and (xi) user selected severity trend information.

18. A non-transitory, computer-readable medium storing instructions, that, when executed by a processor, cause the processor to perform a risk relationship resource model method implemented via a back-end application computer server, the method comprising:
retrieving, by the back-end application computer server from a risk relationship resource model data store, information about a risk relationship resource model including a model version identifier, period definition, and layer information, wherein the risk relationship resource model data store contains electronic records associated with risk relationship resource models, each electronic record including an electronic record identifier;
receiving, from a remote user device, an adjustment to the risk relationship resource model;
executing the adjusted risk relationship resource model, including an experience rating process and an exposure rating process, to generate a prospective resource amount based in part on the period definition and the layer information;
storing, into the risk relationship resource model data store, information about the adjusted risk relationship resource model, including an updated model version identifier; and
facilitating an exchange of data with the remote user device to support interactive actuarial interface displays that collect, calculate, and provide information, including the prospective resource amount.

19. The medium of claim 18, wherein the risk relationship resource model is a reinsurance pricing model and the prospective resource amount comprises a prospective premium.

20. The medium of claim 19, wherein the information in the risk relationship resource model data store includes at least one of: (i) a reinsurance treaty identifier, (ii) historical experience period information, (iii) expiring reinsurance program information, (iv) allocated loss adjustment expenses information, (v) prospective reinsurance program information, (vi) model setup information, (vii) development pattern weights, (viii) layers selection information, and (ix) benchmark information.

21. The medium of claim 19, wherein the layer information includes at least one of: (i) a layer attachment, (ii) a frequency trend status, (iii) benchmark layer amounts, and (iv) benchmark count amounts.
